(19) United States
(12) Patent Application Publication
(10) Pub. No.: US 2003/0007746 A1
(43) Pub. Date: Jan. 9, 2003

(54) PLC chip junction device using an optical sensor

(76) Inventors: Min-Seong Ryu, Seoul (KR); Sang-Yup Song, Suwon-shi (KR); Tae-Hoon Kim, Yongin-shi (KR)

Correspondence Address: CHA & REITER, 411 HACKENSACK AVE, 9TH FLOOR, HACKENSACK, NJ, 07601, US

(21) Appl. No.: 10/140,619

(22) Filed: May 7, 2002

(30) Foreign Application Priority Data
Jul. 6, 2001 (KR) 2001-40255

(51) Int. Cl. G02B 6/42

(52) U.S. Cl. 385/88

(57) ABSTRACT

Disclosed is a junction device for assembling a PLC (Planar Lightwave Circuit) chip and an optical-fiber block used in an optical-communication system. The junction device includes: an ultraviolet-hardening adhesive filled into a space between the interfaces of the PLC chip and the optical-fiber block, the interfaces being inclined at a given angle; an ultraviolet-light source positioned over the ultraviolet-hardening adhesive for hardening the ultraviolet-hardening adhesive; an optical sensor positioned under the ultraviolet-hardening adhesive for measuring the power changes in the ultraviolet output that have penetrated through the ultraviolet-hardening adhesive; an optical power-meter for displaying the power changes of the ultraviolet based on the data received from the optical sensor; and, a controller for detecting when the ultraviolet-hardening adhesive is completely hardened based on data received from the optical power-meter.

### CLAIM OF PRIORITY

This application makes reference to and claims all benefits accruing under 35 U.S.C. Section 119 from an application entitled, “PLC Chip Junction Device Using an Optical Sensor,” filed in the Korean Industrial Property Office on Jul. 6, 2001 and there duly assigned Ser. No. 2001-40255.

### BACKGROUND OF THE INVENTION

1. Field of the Invention

The present invention generally relates to a PLC (Planar Lightwave Circuit) chip and, in particular, to an electrical inter-connection of the PLC chip and electrical components on an integrated package.

2. Description of the Related Art

A WDM (Wavelength Division Multiplexing) communication system is typically used in transmitting a large amount of data, in which a plurality of optical signals having N wavelengths is simultaneously transmitted through a strand of optical fiber. In order to convert the optical signals received into corresponding electrical signals the received optical signals are separated according to their respective wavelengths prior to the conversion process. In a WDM communication system employing a single-mode optical fiber an AWG (Arrayed Waveguide Grating) is widely employed to separate the received optical signals into multiple wavelengths.

Recently, many research efforts have been concentrated on finding an optimal way of integrating an optical waveguide device on a planar substrate using a PLC for many of the optical-signal processing, such as optical-signal dividing, modulation, switching, and multiplexing. Techniques necessary for manufacturing the integrated optical waveguide device include waveguide designing, manufacturing, and packaging. The optical waveguide serves as an optical transmission line, which confines an input light and propagates the input light with low signal loss. The optical waveguide comprises a core having a high refractive index and a cladding having a low refractive index and surrounding the core. The optical waveguide device is manufactured, for example, through the process of depositing multi-layered thin silica or polymer films on a silicon or quartz substrate. By using the difference in the refractive indices between the core and the cladding, the optical waveguide device divides light, changes the light path, and controls the light strength.

FIG. 1 illustrates an array of structures of a PLC chip according to the prior art. For simplicity, an adhesive is not shown in FIG. 1. As shown in FIG. 1, a PLC chip 10 is connected to the optical fibers F1 (a single optical fiber) and F2 (a ribbon optical fiber) through the I/O parts of the optical-fiber blocks 12 and 14, respectively. The PLC chip 10 and the optical-fiber blocks 12 and 14 are aligned in a straight line, and the arrayed arrangement is fixed using an adhesive. In order to feed light into the PLC chip 10 and receive light from the PLC chip 10, the optical-fiber blocks 12 and 14 are positioned and aligned with the I/O ports of the PLC chip 10 in a straight line.

The function of the optical-fiber blocks 12 and 14 is to support the optical fibers F1 and F2. The optical-fiber block is manufactured by forming a V-shaped groove on a silicon substrate, placing an optical fiber in the V-shaped groove, and fixing the optical fiber thereon using an adhesive (or an epoxy resin). In addition, glass plates G1 and G2 are provided to the upper surface of the PLC chip 10, and PYREX™ glass plates G3 and G4 are respectively attached to the upper surface of the optical blocks 12 and 14 to hold the optical fibers F1 and F2 in place. Note that the interfaces 10a, 10b, 12a and 14a between the PLC chip 10 and the optical blocks 12 and 14 are sloped at a specific angle. FIG. 2 illustrates the interfaces 10a, 10b, 12a, and 14a inclined at an angle θ of about 8 degrees relative to the vertical line L so as to reduce the light loss caused by the reflection of light as the light propagates there-through.

With a continued reference to FIG. 2, a description will be made of a conventional junction method, in which the PLC chip and the optical-fiber blocks assembled as shown in FIG. 1 are joined together using an ultraviolet-light source 16 and an adhesive B. In particular, FIG. 2 shows a conventional junction structure between the PLC chip 10 and the optical-fiber block 14.

After aligning the PLC chip 10 and the optical-fiber block 14 in a line, the adhesive B (preferably, an ultraviolet-hardening resin) is applied to the interfaces 10b and 14a and later becomes hardened. The hardening process is performed by applying ultraviolet rays to the applied adhesive for a given time using the ultraviolet-light source 16, thereby fixing the arrayed state. That is, in the conventional junction method, after the adhesive is applied to the interfaces, the applied adhesive is hardened using the ultraviolet-light source 16. A Lens 18 provided to the ultra-violet source 16 guides the ultraviolet rays irradiated by the ultraviolet-light source 16.

However, as the ultraviolet-light source 16 is positioned over the inclined interfaces 10b and 14a in the conventional method, the ultraviolet rays 16a irradiated by the ultraviolet-light source 16 and guided by the lens 18 are diagonally applied to the adhesive B disposed between the inclined interfaces. As such, the lower part of the applied adhesive B does not become hardened properly, while the upper part of the applied adhesive B is well hardened. This is because the ultraviolet rays 16a cannot penetrate the lower part of the applied adhesive B due to the inclined interfaces, which in turn cause an undesirable twist phenomenon in the junction structure during the subsequent processes, thereby deteriorating the reliability of an optical device.

### SUMMARY OF THE INVENTION

The present invention is directed to a junction device for efficiently hardening the adhesive applied to interfaces between a PLC chip and an optical-fiber block.

One aspect of the invention is to provide a junction device for accurately detecting the time when the applied adhesive is completely hardened by measuring changes in the ultraviolet transmissiveness of an adhesive material.

Accordingly, there is provided a junction device for arraying a PLC chip and an optical-fiber block and fixing the arrayed state. The junction device includes: an ultraviolet-hardening adhesive filled into a space between the interfaces of the PLC chip and the optical-fiber block, the interfaces being inclined at a given angle relative to a vertical line; an ultraviolet-light source positioned over the ultraviolet-hardening adhesive for hardening the ultraviolet-hardening adhesive; an optical sensor positioned under the ultraviolet-hardening adhesive for measuring changes in the ultraviolet power that has penetrated the ultraviolet-hardening adhesive; an optical power-meter for displaying the power changes in the ultraviolet using data received from the optical sensor; and, a controller for detecting the time when the ultraviolet-hardening adhesive is completely hardened based on the data received from the optical power-meter.

According to another aspect of the invention, a method of assembling a PLC (Planar Lightwave Circuit) module is provided. The method includes the steps of: providing an optical/electrical device having a PLC (Planar Lightwave Circuit) chip and an optical-fiber block, the contacting surface between the PLC chip and the optical-fiber block having an inclined contact area at a predetermined angle; providing an adhesive material between the contact area of the PLC chip and the optical-fiber block; applying an ultraviolet ray to the adhesive material at the predetermined angle to harden the adhesive material; and, monitoring a change in the ultraviolet ray output that has penetrated the adhesive material in a substantially vertical direction. The method further includes the step of stopping the ultraviolet ray to the adhesive material when there is no change in the ultraviolet-ray output.

### BRIEF DESCRIPTION OF THE DRAWINGS

The above and other features and advantages of the present invention will become more apparent from the following detailed description when taken in conjunction with the accompanying drawings in which:

FIG. 1 is a perspective view of a PLC chip and the I/O parts' optical-fiber blocks, which are arrayed according to the conventional art;

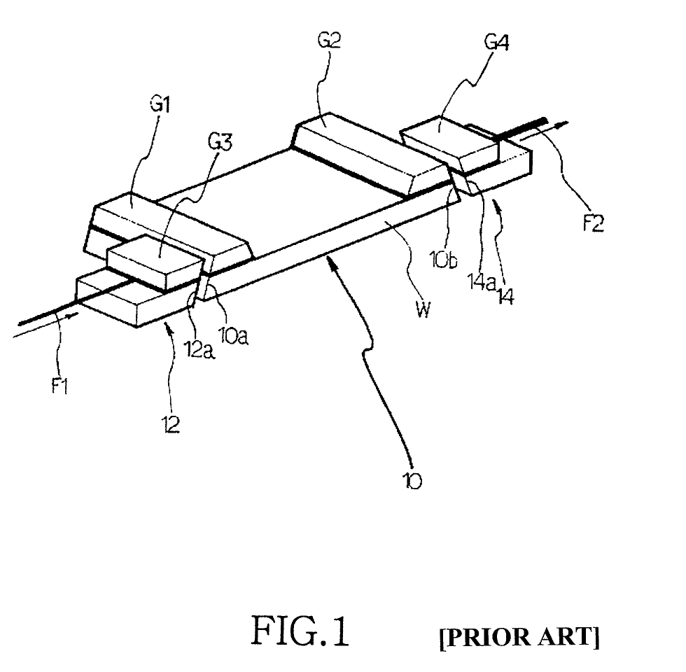

FIG. 2 is a schematic diagram illustrating a conventional method of applying an adhesive to the interfaces between the PLC chip and the output part of the optical-fiber block and hardening the adhesive to fix the arrayed state; and,

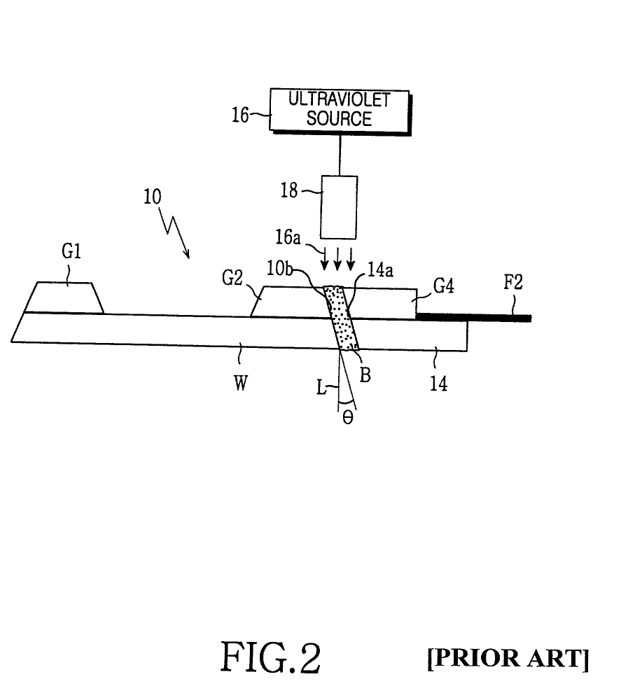

FIG. 3 is a schematic diagram illustrating a junction device and its related method for applying an adhesive to the interfaces between the PLC chip and the optical-fiber block and hardening the adhesive to fix the arrayed state according to a preferred embodiment of the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail. It should be noted that an optical-fiber-block assembly mentioned in this disclosure indicates an optical-fiber block with a cover.

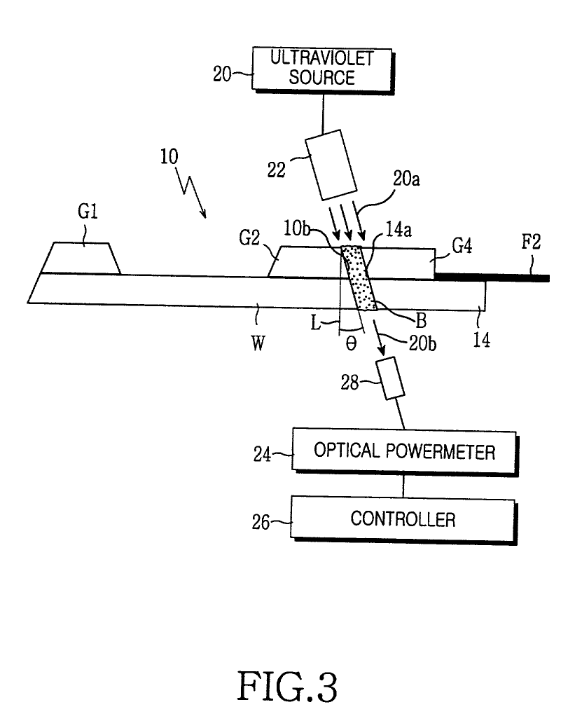

FIG. 3 illustrates the structure of a junction device for applying the adhesive to the interfaces between the arrayed PLC chip and optical-fiber block to be hardened by an ultraviolet source according to the preferred embodiment of the present invention.

As shown in FIG. 3, the junction device according to the preferred embodiment of the present invention is capable of joining the PLC chip 10 and the optical-fiber block 14 in a precise manner. The PLC chip 10 is manufactured through a known process of depositing multi-layered thin silica or polymer films on a planar silicon wafer W. Due to the difference in the refractive indices between a core and a cladding surrounding the core, an optical signal can be propagated through a waveguide of the PLC chip 10. The PLC chip 10 and the optical-fiber block 14 are arrayed in a line and then fixedly joined together. Although FIG. 3 shows only the junction structure between the PLC chip 10 and the optical-fiber block 14, the junction structure also can be applied to joining the PLC chip 10 and the optical-fiber block 12. Thus, the drawing should not impose a limitation on the scope of the present invention. Note that the arrayed PLC chip 10 and optical-fiber block 14 are packed into a housing (not shown) later as an optical-communication module.

The PLC chip 10 multiplexes/demultiplexes, divides, modulates, or switches propagating signals therethrough according to the waveguide designed on the silicon wafer W. The glass plates G1 and G2 are respectively attached to the I/O parts of the silicon wafer W so as to facilitate a manufacturing process. It should be noted that the PLC chip 10 is well known by those skilled in the art, thus a detailed description of the PLC chip 10 is omitted.

The optical-fiber block 14 includes a V-shaped groove (not shown) for receiving the optical fiber F2. To this end, the optical-fiber block 14 is used to couple the optical fiber F2 and the output port of the waveguide of the PLC chip 10. In addition, the PYREX™ glass plate G4 is attached to the top of the optical-fiber block 14 to hold the optical fiber F2 positioned on the V-shaped groove.

The interfaces 10b and 14a between the PLC chip 10 and the optical blocks 14 are sloped at a given angle relative to the vertical line, L. Specifically, the interfaces 10b and 14a are inclined at a slope angle θ of about 8 degrees to the vertical line L so as to reduce the light loss due to the reflection of light during the propagation stage. To fixedly hold the PLC chip 10 and the optical-fiber block 14 in a straight line, an adhesive B (specifically, an ultraviolet-hardening resin) is filled into a space between the interfaces 10b and 14a, then hardened using an ultraviolet light source 20. The present invention further provides a process of precisely measuring the power of ultraviolet rays 20b in real time during the hardening process so as to perform precisely the hardening operation. To this end, the junction device includes the ultraviolet-light source 20 positioned over the applied adhesive B and an ultraviolet-power measuring means (specifically, an optical sensor 28) positioned under the applied adhesive B to measure in real time the changes in the power of the ultraviolet rays 20b that have penetrated the applied adhesive B during the hardening process.

In the embodiment, the ultraviolet-light source 20 includes a lens 22 for transmitting the ultraviolet rays irradiated by the ultraviolet-light source 20 to the applied adhesive B. As the lens 22 and the applied adhesive B are arrayed in a straight line, ultraviolet rays 20a penetrating the lens 20 can be applied to the applied adhesive B in a straight path, thus uniformly passing through the adhesive. As a result, the straight traveling of the ultraviolet rays 20a through the adhesive B minimize the loss due to the reflection of the ultraviolet rays 20a as in the prior art system.

The optical sensor 28 measures the changes in the output power of the ultraviolet rays 20b that have penetrated the applied adhesive B, then provides the measured data to an optical power-meter 24. The optical power-meter 24 displays the measured data provided from the optical sensor 28 and provides the measured data to a controller 26. The controller 26 detects when the applied adhesive B is completely hardened using the measured data. As the hardening process progresses, the light transmissiveness of the applied adhesive B changes. In general, the light transmissiveness increases or decreases according to the hardening-operation progress. After the applied adhesive B is completely hardened, the strength of light penetrating the completely hardened adhesive B does not change anymore. Therefore, the junction device according to the present invention can find out the time when the applied adhesive B is completely hardened, by measuring the strength of the light penetrating the applied adhesive during the progress of the hardening process.

A description will be made now of the hardening process according to the present invention. After the ultraviolet-light source 20 and the lens 22 are arrayed so that the strength of the ultraviolet rays 20b can be maximized, the adhesive B that can be hardened by an ultraviolet is filled into the space between the interfaces 10b and 14a. When the adhesive B penetrates evenly into the space, the ultraviolet-light source 20 is turned on. The strength of the ultraviolet rays 20b is measured using the optical sensor 28. As the hardening process progresses, the strength of the ultraviolet rays 20b varies. After a lapse of a given time, the strength of the ultraviolet rays 20b does not vary anymore. At this time, the hardening process ends.

As described above, the present invention can array optimally the ultraviolet-light source and the adhesive applied to the interfaces between the PLC chip and the optical-fiber block, then precisely find out the point when the applied adhesive is completely hardened by measuring the strength of the ultraviolet rays that have penetrated the applied adhesive using the optical sensor positioned under the applied adhesive. As a result, the present invention can reduce the whole hardening process and increase reliability on the optical device.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A junction device for assembling a PLC (Planar Lightwave Circuit) chip and an optical-fiber block, comprising:
an adhesive material disposed between the PLC chip and the optical-fiber block, the PLC chip and the optical-fiber block having an inclined surface area at a predetermined angle;
an ultraviolet-light source positioned over the ultraviolet-hardening adhesive for providing an ultraviolet ray to harden the adhesive material;
an optical sensor positioned under the ultraviolet-hardening adhesive for measuring a power change of the ultraviolet ray that has penetrated the adhesive material;
an optical power-meter for displaying the power change in the ultraviolet ray based on the output from the optical sensor; and,
a controller for detecting when the adhesive material is completely hardened based on the output from the optical power-meter.

2. The device as claimed in claim 1, wherein the ultraviolet-light source and the adhesive material are arrayed so that ultraviolet ray radiated by the ultraviolet-light source can be applied to the adhesive material in a substantially straight path.

3. The device as claimed in claim 1, wherein the optical sensor and the adhesive material are arrayed in a substantially straight line so that the optical sensor can measure the power change of the ultraviolet ray outputted through the adhesive material.

4. A method for assembling a PLC (Planar Lightwave Circuit) module, the method comprising the steps of:
providing an optical/electrical device having a PLC (Planar Lightwave Circuit) chip and an optical-fiber block, the contacting surface between the PLC chip and the optical-fiber block having an inclined contact area at a predetermined angle;
providing an adhesive material between the contact area of the PLC chip and the optical-fiber block;
applying an ultraviolet ray to the adhesive material at the predetermined angle to harden the adhesive material; and, monitoring a change in the ultraviolet-ray output that has penetrated the adhesive material in a substantially vertical direction.

5. The method of claim 4, further comprising the step of stopping the ultraviolet ray to the adhesive material when there is no change in the ultraviolet-ray output.
